(19) United States
(12) Patent Application Publication
(10) Pub. No.: US 2009/0159167 A1
(43) Pub. Date: Jun. 25, 2009

(54) PNEUMATIC TIRE TREAD WITH SIPES AND MOLD BLADE

(76) Inventor: Daniel Scheuren, Arlon (BE)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(21) Appl. No.: 12/203,996

(22) Filed: Sep. 4, 2008

Related U.S. Application Data
(60) Provisional application No. 61/015,446, filed on Dec. 20, 2007.

(51) Int. Cl. B60C 11/13; B28B 7/00

(52) U.S. Cl. 152/209.18; 425/470

(57) ABSTRACT

The invention provides a tire tread, the tread having at least one circumferentially extending or laterally extending main groove, the maximum radial depth of the at least one main groove defining a non-skid tread depth, the at least one main groove partially forming at least one tread element, the at least one tread element having a sipe therein, wherein the sipe has a first portion and a second radiused portion, and a transition section located between the first portion and the second portion, the transition section having a curved surface with an outer radius that has a center external to the sipe, wherein the ratio of r1/r2 ranges from about 0.1 mm to about 16 mm. The invention further includes a blade for molding a tire, the blade comprising a first portion and a second circular portion having a radius r2, and a curved transition section located between the first portion and the second portion, the transition section having an outer radius r1 that has a center external to the sipe, wherein the ratio of r1/r2 ranges from about 0.3 mm to about 4 mm.

This application claims the benefit of, and incorporates by reference, U.S. Provisional Application No. 61/015,446 filed Dec. 20, 2007.

### FIELD OF THE INVENTION

The present invention is directed to a pneumatic tire having sipes. More particularly, the present invention is directed to a tire tread wherein the bottom of the blade is designed to significantly improve the resistance to fatigue cracks.

### BACKGROUND OF THE INVENTION

Tires commonly utilize sipes in the tire tread for wet traction. As the grooves increase in size and depth, fatigue cracks in the tread block may occur at the sipe bottom. This may be caused by fatigue due to the repeated cyclic loading due to braking torque. As the groove depth increases, it makes it more difficult to extract the blade from the cured tire without damaging the tire. Further, depending upon the groove shape, rubber may chunk at the intersection of the sipe and groove.

Thus an improved blade and sipe geometrical configuration is desired, which alleviates all the disadvantages described above.

### SUMMARY OF THE INVENTION

The invention provides in a first aspect a tire tread, the tread having at least one circumferentially extending or laterally extending main groove, the maximum radial depth of the at least one main groove defining a non-skid tread depth, the at least one main groove partially forming at least one tread element, the at least one tread element having a sipe therein, wherein the sipe has a first portion and a second radiused portion, and a transition section located between the first portion and the second portion, the transition section having a curved surface with an outer radius that has a center external to the sipe, wherein the radius of the transition section ranges from about 0.5 mm to about 8 mm and wherein the radius of the second portion ranges from about 0.5 to about 5 mm.

The invention provides in a second aspect a blade for molding a tire, the blade comprising a first portion and a second circular portion having a radius r2, and a curved transition section located between the first portion and the second portion, the transition section having an outer radius r1 that has a center external to the sipe, wherein the ratio of r1/r2 ranges from about 0.1 mm to about 16 mm.

The invention provides in a third aspect a tire tread, the tread having at least one circumferentially extending or laterally extending main groove, the maximum radial depth of the at least one main groove defining a non-skid tread depth, the at least one main groove partially forming at least one tread element, the at least one tread element having a sipe therein, wherein the sipe has a first portion and a second radiused portion, and a transition section located between the first portion and the second portion, the transition section having a curved surface with an outer radius that has a center external to the sipe, wherein the ratio of r1/r2 ranges from about 0.1 mm to about 16 mm.

### Definitions

The following definitions are controlling for the disclosed invention.

“Blade” means a protrusion in a tire curing mold that forms part of the tread design. The protrusion forms a corresponding depression in the finished tire tread.

“Groove” means an elongated void area in a tread that may extend circumferentially or laterally about the tread in a straight, curved, or zigzag manner. Circumferentially and laterally extending grooves sometimes have common portions and may be sub classified as “wide” or “narrow.” A “narrow groove” has a width greater than a sipe, but less than or equal to about 4.0 mm and a “wide groove” has a width greater than about 4.0 mm. The groove width is equal to tread surface area occupied by a groove or groove portion, the width of which is in question, divided by the length of such groove or groove portion; thus, the groove width is its average width over its length.

“Radial” and “radially” are used to mean directions radially toward or away from the axis of rotation of the tire.

“Sipes” refer to very narrow width grooves molded into tread elements of a tire that subdivide the tread elements. Sipes have a width in the range of about 0.3 mm to about 1.0 mm. The width of a sipe is such that the sipe tends to close completely in a tire footprint.

### BRIEF DESCRIPTION OF THE DRAWINGS

The invention will be described by way of example and with reference to the accompanying drawings in which:

FIG. 1 is a perspective view of a tread element in accordance with the invention;

FIG. 2 is an exemplary blade used to form one embodiment of the invention;

FIG. 3 is a cross-sectional view of the blade of FIG. 2;

FIG. 4 is an enlarged cross-sectional view of the lower blade portion of FIG. 3;

FIGS. 5A-5D illustrate example blade cross-sectional views with a blade thickness of 0.8 mm, an r2 radius of 1.5 mm, and illustrate a r1 radius of: 1 mm (FIG. 5A), 1.5 mm (FIG. 5B), 3.0 mm (FIG. 5C), and 6 mm (FIG. 5D), respectively;

FIGS. 6A-6D illustrate example blade cross-sectional views, each with a blade thickness of 0.5 mm, an r2 radius of 1.5 mm, and illustrate an r1 radius of: 1 mm (FIG. 6A), 1.5 mm (FIG. 6B), 3.0 mm (FIG. 6C), and 6 mm (FIG. 6D), respectively;

FIGS. 7A-7D illustrate example blade cross-sectional views, each view with a blade thickness of 0.8 mm, an r2 radius of 2.4 mm, and an r1 radius of: 1 mm (FIG. 7A), 1.5 mm (FIG. 7B) 3.0 mm (FIG. 7C), and 6 mm (FIG. 7D), respectively;

FIG. 8 illustrates a second embodiment of a blade of the invention; and

FIG. 9 illustrates the cross-sectional view of the blade of FIG. 8.

### DETAILED DESCRIPTION OF THE INVENTION

The following language is of the best presently contemplated mode or modes of carrying out the invention. This description is made for the purpose of illustrating the general principles of the invention and should not be taken in a limiting sense. The scope of the invention is best determined by reference to the appended claims.

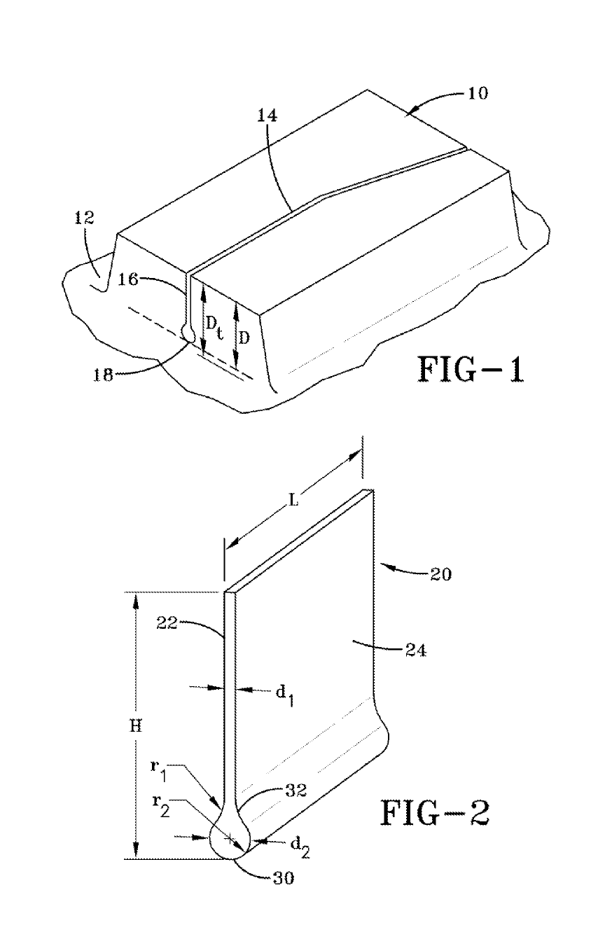

FIG. 1 is a tread element 10 for a pneumatic tire tread. As appreciated by those skilled in the art, the tread element 10 is formed by at least one groove 12, the groove 12 being either a circumferentially extending or laterally extending groove. If the tread element 10 is defined by only circumferentially extending grooves, the tread element will be a tread rib. If the tread element 10 is formed by grooves on at least three sides, the tread element 10 is considered a tread block. The tread element 10 may be located in any position on the tread surface, i.e. along a tread shoulder, along the centerline, or an intermediate position. The depth of the grooves 12 forming the tire tread elements defines the non-skid depth Dt of the tread. If there are grooves of differing depths, the maximum groove depth will define the non-skid depth of the tread.

Located within the tread element 10 is at least one sipe 14. The sipe 14 is illustrated as subdividing the tread element 10 into two portions; however, the tread element 10 may have multiple sipes 14. The sipe 14 may be straight, curved or have a general inclination in either the lateral or circumferential direction of the tire; the exact orientation of the sipe 14 relative to the tread is within the purview of the tread designer.

The sipe 14 has a radially outer portion 16 having a width d1 which may be in the range of about 0.3 to about 1.0 mm, more preferably about 0.5 to 0.8 mm. Preferably, the width d₁ is constant; however, the width of the radially outer sipe portion may vary. The sipe further comprises a radially inner portion 18 that has a diameter d2 which is larger than d₁, and may be in the range of about 1. to 10.0 mm, more preferably in the range of about 2 to about 6, and most preferably in the range of about 2 to about 4 mm. The width range upper limit of the radially inner sipe portion 18 is limited by the ability to demold the tire and remove the forming blade without destroying the radially outer sipe portion 16.

In a preferred embodiment of the invention, the following relationship applies to the blade: d₁<d₂<8*d₁. More preferably, d₂>2*d₁. Even more preferably, d₂>2.5*d₁. For example, d1 may be 0.8 mm, and d2 may be 3 mm.

The sipe 14 may be formed from a mold blade 20 as shown in FIG. 2. During molding of the tire tread, the blade 20 forms a sipe 14 that has a profile corresponding to the blade configuration. Thus, in the following discussion, references to the blade pattern and dimensions are also applicable to the sipe 14 formed therefrom and may be so referred to.

The blade 20 is typically formed of metal such as steel. The blade, depending upon the shape, may be direct milled, cast or formed by stamping or embossing. The blade 20 comprises a first portion 22 that has a depth d1 in the range of about 0.3 mm to about 0.8 mm, more preferably about 0.5 to 0.8 mm. Preferably, the width d₁ is constant; however, the width of the radially outer blade portion may vary. In a first embodiment, the first portion 22 is formed from a flat, planar plate 24 having a defined length, height h and thickness d₁. As described below, the first portion may also be curved or have three dimensional projections, or combinations thereof. The mold blade 20 further comprises a second portion 30 that is typically located on one end of the plate 24, although not required. The second portion 30 comprises an enlarged, rounded cross section or bulbous shape or, as the inventor would describe, the shape of a falling rain drop. The second portion 30 is joined to the first portion 22 with no corners or discontinuities. Preferably the second portion is joined to the first portion 22 with a transition portion 32 defining a radiused smooth transition having its center located outside the second portion 30. The transition portion may comprise a radius r₁ in the range of about 0.5 to about 8 mm, more preferably about 1 to about 3 mm. The second portion radius r₂ may range from about 0.5 mm or greater, more typically about 0.5 mm to about 5 mm, and preferably about 1.5 mm to about 2.5 mm. The ratio of the transition radius to the second portion radius, r₁/r₂ may range from about 0.1 to about 16, and more typically about 0.3 to about 4.

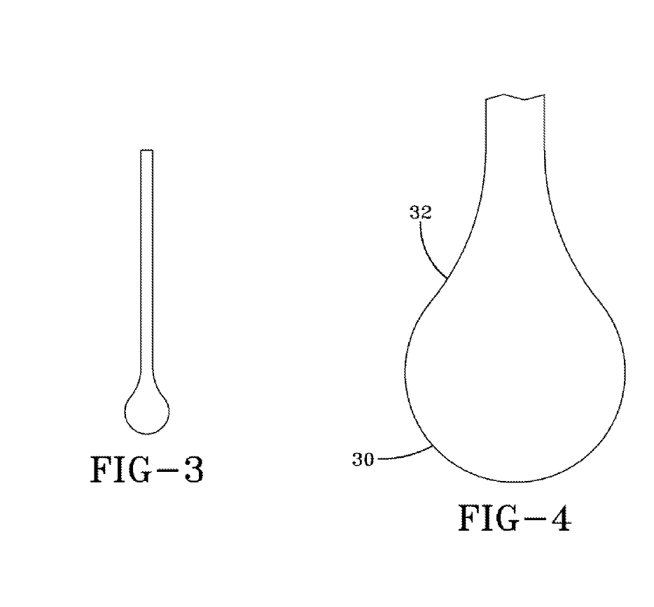

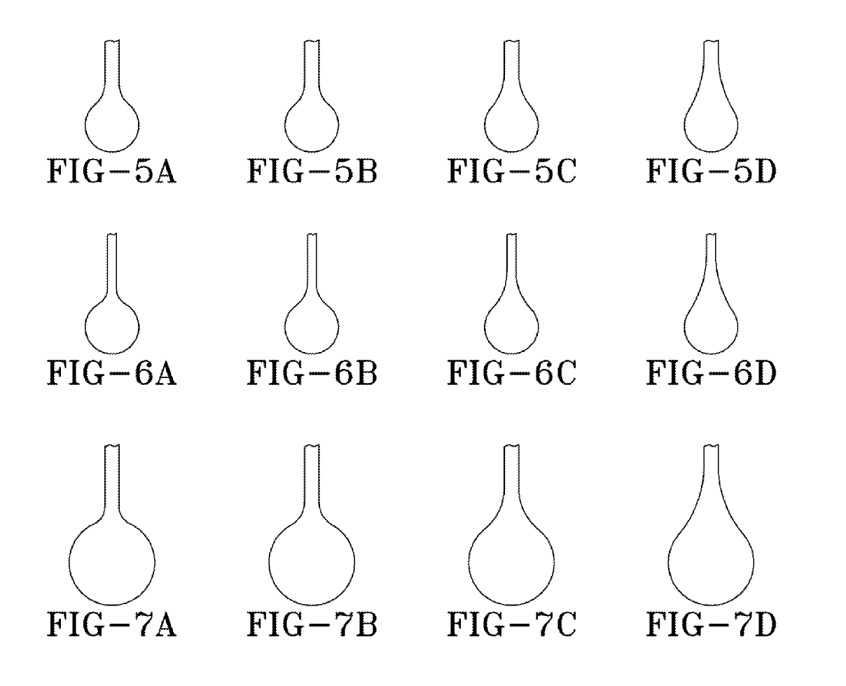

FIGS. 5A-5D illustrate a cross-sectional view of the transition portion and the second portion, wherein the blade has a thickness of about 0.8 mm and a bulb radius r2 of 1.5 mm. The transition radius r1 varies from about 1 mm as shown in FIG. 5A, 1.5 mm in FIG. 5B, 3.0 mm in FIG. 5C, and 6 mm in FIG. 5D. As the transition radius increases, the transition section elongates. FIGS. 6A through 6D illustrate a blade depth of about 0.5 mm, a second portion radius r₂ of about 1.5 mm, and the transition radius r₁ varies from about 1 mm as shown in FIG. 6A, 1.5 mm in FIG. 6B, 3.0 mm in FIG. 6C, and 6 mm in FIG. 6D. FIGS. 7A-7D illustrate a much larger bulb radius r₂ of about 2.4 mm, with a blade thickness of about 0.8 mm. The transition radius r₁ varies from about 1 mm as shown in FIG. 7A, 1.5 mm in FIG. 7B, 3.0 mm in FIG. 7C, and 6 mm in FIG. 7D. As the transition radius increases, a more distinct and elongated transition section is created, that looks like a falling raindrop.

The blade 20 of the above described embodiment may also be straight, curved or angled along its length 1.

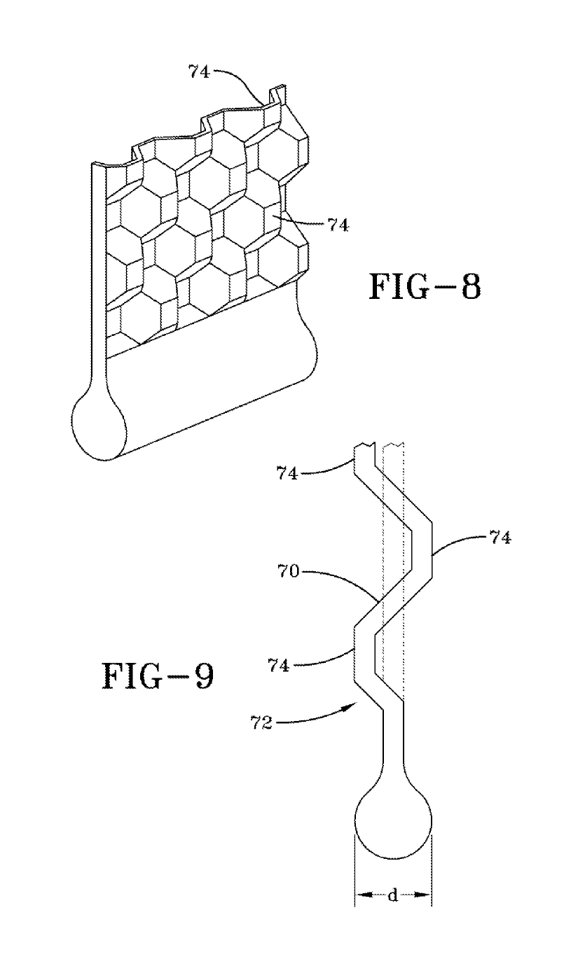

FIGS. 8 and 9 illustrate a second embodiment of the invention. The blade 60 is the same as above, except for the following differences. The blade first portion 70 is not smooth and flat. The planar first portion comprises a plurality of projections 72 and recessed portions. The top portion of the projection 74 may be flat or planar. The recessed portions may extend into the opposite direction of the projection 74, and have a flat recessed portion 74. Alternatively, the top portion of the projection may be rounded (not shown). The projections may be aligned in one or more rows. If two or more radially adjacent rows are utilized, the projections may be aligned or staggered such that the centers of the projections are offset. The projections may be spaced apart with planar sections (not shown) or the projections may be closely spaced as shown. The projections may vary in shape, or be the same shape.

The invention is not limited to a sipe. The shape of the raindrop may also be applied to a groove. A tire tread, the tread having at least one circumferentially extending or laterally extending main groove, the maximum radial depth of the at least one main groove defining a non-skid tread depth, the at least one main groove partially forming at least one tread element, the at least one tread element having a sipe therein.

While a certain representative embodiment and details have been shown for the purpose of illustrating the invention, it will be apparent to those skilled in the art that various changes and modifications may be made therein without departing from the spirit or scope of the invention.

What is claimed is:

1. A tire tread, the tread having at least one circumferentially extending or laterally extending main groove, the maximum radial depth of the at least one main groove defining a non-skid tread depth, the at least one main groove partially forming at least one tread element, the at least one tread element having a sipe therein
wherein the sipe has a first portion and a second radiused portion, and a transition section located between the first portion and the second portion, the transition section having a curved surface with an outer radius that has a center external to the sipe,
wherein the radius of the transition section ranges from about 0.5 mm to about 8 mm and
wherein the radius of the second portion ranges from about 0.5 to about 5 mm.

2. The tire tread of claim 1 wherein the first portion is located radially outwards of the second portion, and wherein the first portion has a constant width less than the width of the second portion.

3. The tread of claim 1 wherein the first portion has a substantially straight configuration.

4. The tread of claim 1 wherein the first portion of the sipe has a non-straight configuration.

5. The tread of claim 1 wherein the radially outer portion has a three dimensional configuration comprises a series of protrusions and recesses.

6. A blade for molding a tire, the blade comprising a first portion and a second circular portion having a radius r2, and a curved transition section located between the first portion and the second portion, the transition section having an outer radius r1 that has a center external to the sipe, wherein the ratio of r1/r2 ranges from about 0.3 mm to about 16 mm.

7. The blade of claim 6 wherein the ratio of r1/r2 ranges from about 1 mm to about 4 mm.

8. The blade of claim 6 wherein the ratio of r1/r2 ranges from about 1 mm to about 3 mm.

9. The blade of claim 6 wherein the ratio of r1/r2 ranges from about 1.5 mm to about 2.5 mm.

10. The blade of claim 6 wherein the first portion has a three dimensional configuration with projections and recessed portions.

11. The blade of claim 6 wherein the blade has a length and the sipe is angled or curved with respect to its length.

12. A tire tread, the tread having at least one circumferentially extending or laterally extending main groove, the maximum radial depth of the at least one main groove defining a non-skid tread depth, the at least one main groove partially forming at least one tread element, the at least one tread element having a sipe therein, wherein the sipe has a first portion and a second radiused portion, and a transition section located between the first portion and the second portion, the transition section having a curved surface with an outer radius that has a center external to the sipe, wherein the ratio of r1/r2 ranges from about 0.1 mm to about 16 mm.

13. A tire tread, the tread having at least one circumferentially extending or laterally extending main groove, the maximum radial depth of the at least one main groove defining a non-skid tread depth, the at least one main groove partially forming at least one tread element, the at least one tread element having a groove therein
wherein the groove has a first portion and a second radiused portion, and a transition section located between the first portion and the second portion, the transition section having a curved surface with an outer radius that has a center external to the groove,
wherein the radius of the transition section ranges from about 0.5 mm to about 8 mm and
wherein the radius of the second portion ranges from about 0.5 to about 5 mm.
